(19) United States
(12) Patent Application Publication
(10) Pub. No.: US 2011/0240677 A1
(43) Pub. Date: Oct. 6, 2011

(54) Airless double-piston double-action pump and cosmetics bottle dispensing device

(76) Inventor: Walter Dwyer, Malibu, CA (US)

(21) Appl. No.: 12/932,668

(22) Filed: Mar. 2, 2011

Related U.S. Application Data
(60) Provisional application No. 61/339,413, filed on Mar. 3, 2010.

(51) Int. Cl. G01F 11/00; B65D 88/54

(52) U.S. Cl. 222/256; 222/321.2; 222/340

(57) ABSTRACT

An airless double-piston double-action pump device comprises a pump assembly, and bottle assembly comprising a volume adjustment piston therein retained by a plug. A nozzle head/valve spool combination is driven from a first to a second position, where the spool openings are exposed beyond a valve seat piston to a cosmetic substance. Continued movement to a third position, ending the down stroke, causes the combination to shrink the reservoir volume and force substance up the spool/nozzle conduit for delivery. During spring-biased nozzle head/spool upstroke, vacuum pressure causes quantities of substance to be drawn upward from the bottle to refill the reservoir, and which also correspondingly causes the bottle piston to adjust vertically. A loose friction fit between the bottle piston and bottle ensures that the bottle piston is static during down strokes, but may be overcome by the vacuum during the spring-biased up stroke.

### CROSS REFERENCES TO RELATED APPLICATIONS

This application claims priority on U.S. Provisional Application No. 61/339,413, filed on Mar. 3, 2010, the disclosures of which are incorporated herein by reference.

### FIELD OF THE INVENTION

The present invention relates to improvements in apparatus used for the dispensing of cosmetic liquids and semi-liquids, and more particularly to apparatus which are capable of providing an airless delivery system for such products.

### BACKGROUND OF THE INVENTION

There are many instances today, both in ordinary home use as well as in commercial or industrial environments, where there is a need to have a means of applying liquids, creams, and the like. The same is true for the highly specialized products sold within the cosmetics industry, particularly for those which may need to be pumped from a bottle, whether they are in the form of liquid perfumes or other liquid products, or a more viscous product like hand lotions.

The standard delivery system used in such instances is the reciprocating piston pump found in spray bottles delivering liquid cleaners and creamy hand soaps. Such arrangements involve a tube connecting the bottom of the container bottle to a float valve, which serves to maintain fluid in a reservoir. A spring biased piston may be actuated by a trigger to seal the float valve (usually a spring-loaded ball bearing) at the bottle, and simultaneously open an exit valve. As the piston is pushed inward, it decreases the available volume within the reservoir, and forces liquid to open the exit valve and be expelled beyond it onto a target surface. Such reciprocating piston pump delivery systems have appeared in various forms within a number of patents, including U.S. Pat. No. 4,097,203 to Selwood, and U.S. Pat. No. 5,011,382 to Thompson.

The problem with these reciprocating pump piston devices is that they invariable involve continuous exposure of the reservoir of the substance to an air pocket, as a result of the piston withdrawing from the chamber. This is particularly disadvantageous for preserving the moisture balance, and chemical composition of highly specialized cosmetic substances. The invention disclosed herein solves this problem with a unique double-piston pump and bottle configuration, which furthermore eliminates the need for the formula to flow through and past the spring and ball bearing.

### OBJECTS OF THE INVENTION

It is an object of the invention to provide a means for delivering cosmetic liquids, and the like.

It is another object of the invention to provide a means for pumping cosmetics liquids and semi-liquids from a bottle without the use of air of any other gas propellant typical of aerosol delivery system.

It is a further object of the invention to provide a means of preventing large volumes of cosmetics substance from remaining at the bottom of the bottle because of an inability to pump it therefrom.

Further objects and advantages of the invention will become apparent from the following description and claims, and from the accompanying drawings.

### SUMMARY OF THE INVENTION

An airless double-piston “double-action” pump device may be comprised of a bottle cylinder within which is disposed a slidable piston. The slidable piston may be installed within the bottle cylinder and retained within the bottle cylinder through a bottom end opening which is later covered by a bottle plug. The bottle cylinder may have a threaded spout at the top end, which is threadably received within the pump assembly.

The pump assembly may be comprised of several parts which comprise two principle subassemblies (FIG. 5A). A nozzle casing may be selectively hollowed out to receive a valve housing in a friction fit or be otherwise fixed therein. A nozzle head having cylindrical extensions with interior conduits may be slidable inserted into the casing, and be spring biased upward relative to the valve housing. The nozzle head may be retained in a first position through its connection with the second sub-assembly.

The second subassembly may be comprised of a valve inlet sleeve that is hollowed out to slidably receive a valve seat piston. The valve seat piston may slidably receive a valve spool, which has a shaft extending upward from a cylindrical head. The second subassembly may be installed into the first sub-assembly by a friction fit or by gluing of the valve sleeve to the valve housing, and by simultaneously sliding the shaft of the valve spool into the cylindrical extension of the nozzle head, where it may also be affixed by a friction fit or gluing it therein.

The user pumping the nozzle head causes the valve spool to descend and initially exposes an inlet orifice, which is interconnected to a chamber within the shaft and also to the chambers within the nozzle head. Continued downward motion of the valve spool causes the valve seat piston to also descend, which forces cosmetic liquid into the orifice and out the nozzle head. As the nozzle head begins to move upward in the up stroke, a flapper valve arrangement between the valve inlet sleeve and the bottle opens, and permits cosmetics fluid to be drawn upward, which simultaneously causes the bottle piston to move vertically as well. The bottle piston does not move downward during the down stroke as the flapper valve seals the valve inlet sleeve to bottle connection, preventing the fluid displacing downward movement of the valve seat piston from similarly causing the bottle piston to descend, and as a result, it movement only causes fluid to climb up through the chambers and be pumped out the nozzle head.

### BRIEF DESCRIPTION OF THE DRAWINGS

FIG. 1 is a cross-sectional view of a first embodiment of the bottle with dispensing device and cap of the present invention, with the cap attached to the device.

FIG. 2 is a cross-sectional view of a first embodiment of the bottle with dispensing device and cap of the present invention, with the cap removed from the device.

FIG. 3 is an enlarged cross-sectional view of the first embodiment of the bottle assembly with the pump assembly of the present invention.

FIG. 4A is an enlarged cross-sectional view of the first embodiment of the bottle assembly with the pump assembly of the present invention in the first position, and with the bottle cylinder broken to move the top and bottom of the assemblies closer together.

FIG. 4B is the enlarged cross-sectional view of FIG. 4A, but with the nozzle/valve spool combination actuated downward to a second position where the nozzle contacts the valve seat piston.

FIG. 4C is the enlarged cross-sectional view of FIG. 4B, but where the nozzle/valve spool combination has been further actuated downward to a third position and having simultaneously driven the valve seat piston.

FIG. 4D is the enlarged cross-sectional view of FIG. 4C, but where the nozzle/valve spool combination has been biased upward relative to the valve seat piston, which seals off the spool openings.

FIG. 5 is an enlarged cross-sectional view of the dispensing valve portion of the present invention shown detached from the bottle cylinder.

FIG. 5A is an enlarged cross-sectional view of the dispensing valve portion of the present invention shown detached from the bottle cylinder, and at a sub-assembly stage.

FIG. 6 is an exploded view of the component parts of the dispensing device of the present invention.

FIG. 7 is a cross-sectional view of the nozzle head of the present invention.

FIG. 8 is a cross-sectional view of the nozzle casing of the present invention.

FIG. 9 is a cross-sectional view of the head biasing spring of the present invention.

FIG. 10 is a cross-sectional view of the valve housing of the present invention.

FIG. 11 is a cross-sectional view of the valve seat piston of the present invention.

FIG. 12 is a cross-sectional view of the valve spool of the present invention.

FIG. 13 is a cross-sectional view of the valve inlet sleeve of the present invention.

FIG. 14 is a cross-sectional view of the bottle sealing member of the present invention.

FIG. 15 is a cross-sectional view of the bottle cylinder of the present invention.

FIG. 15A is an enlarged cross-sectional view of the bottle cylinder spout of FIG. 15.

FIG. 16 is a top view of the bottle cylinder of FIG. 15.

FIG. 17 is a perspective view of the bottle cylinder of the present invention.

FIG. 18 is a cross-sectional view of the of the bottle piston present invention.

FIG. 19 is a cross-sectional view of the bottle plug of the present invention.

### DETAILED DESCRIPTION OF THE INVENTION

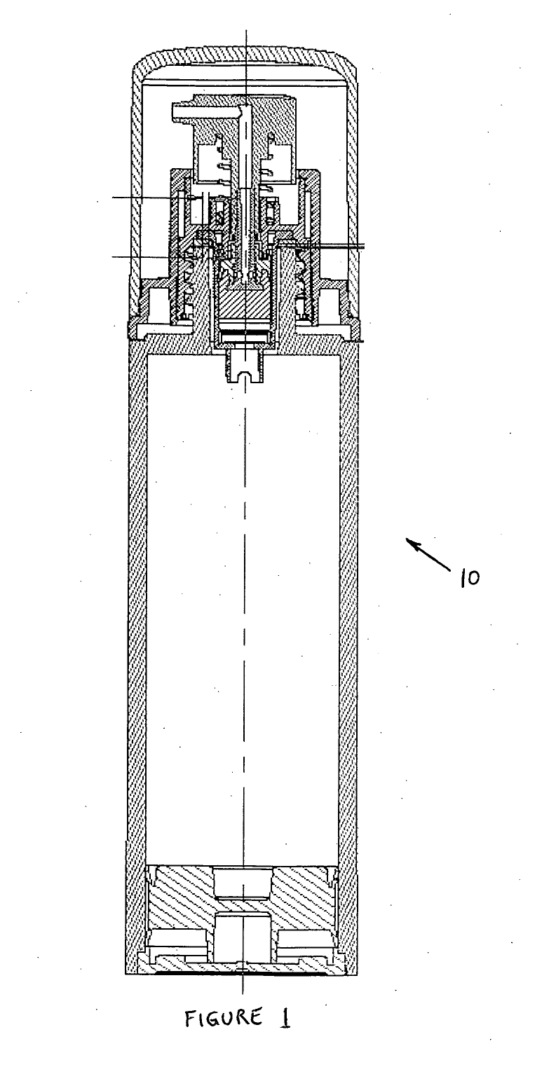

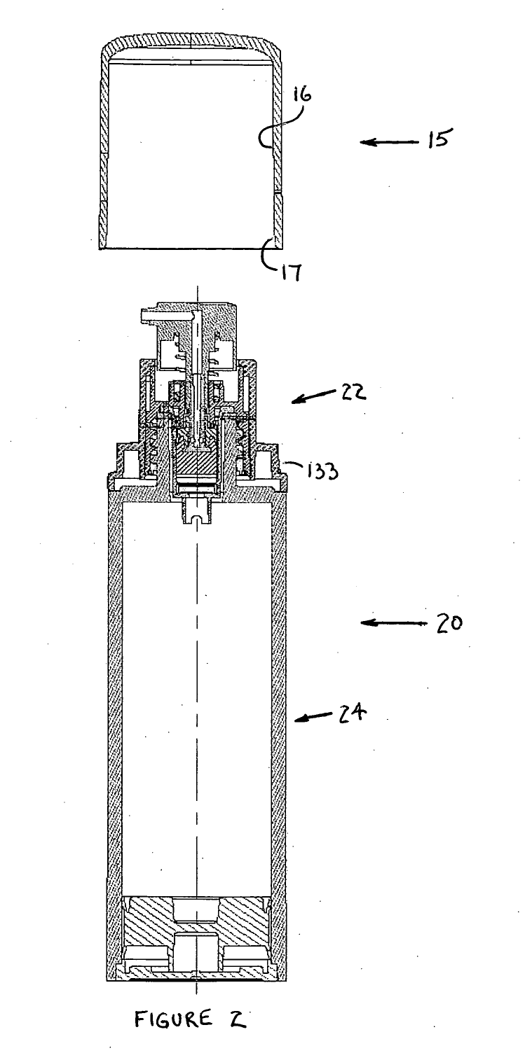

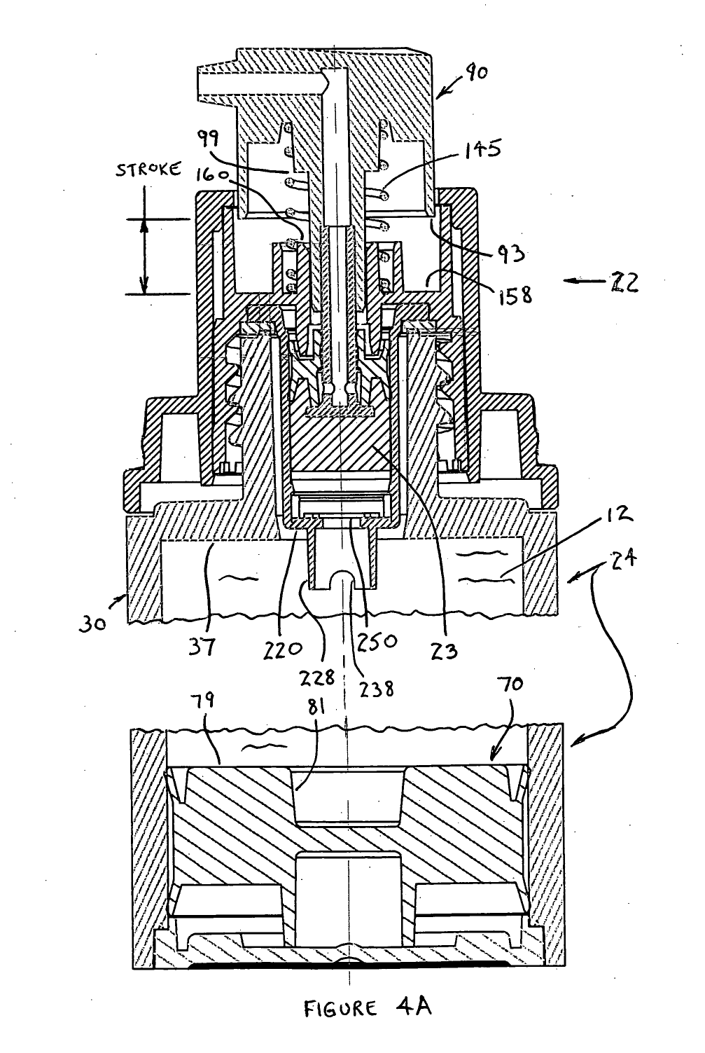

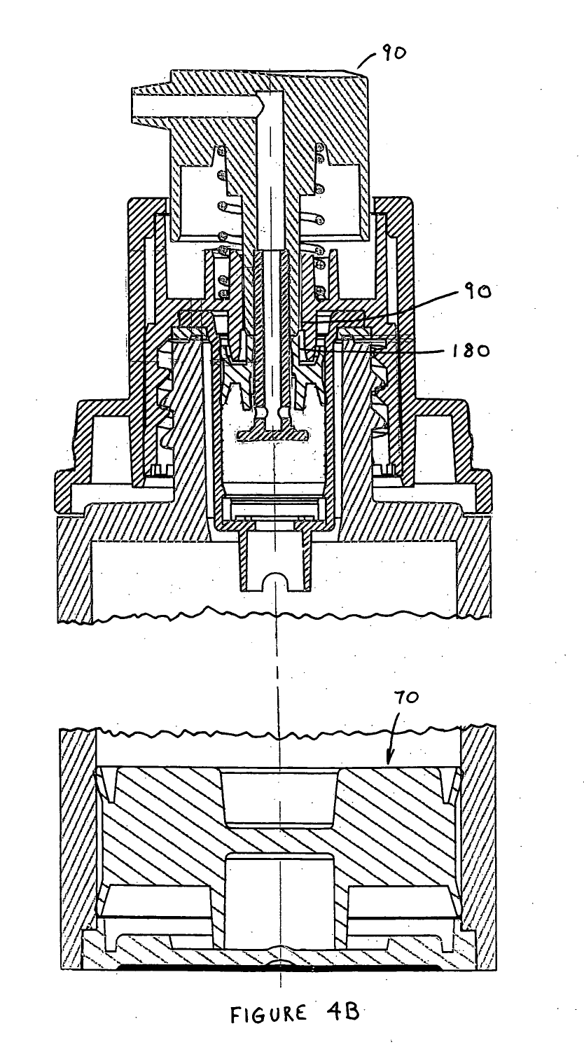

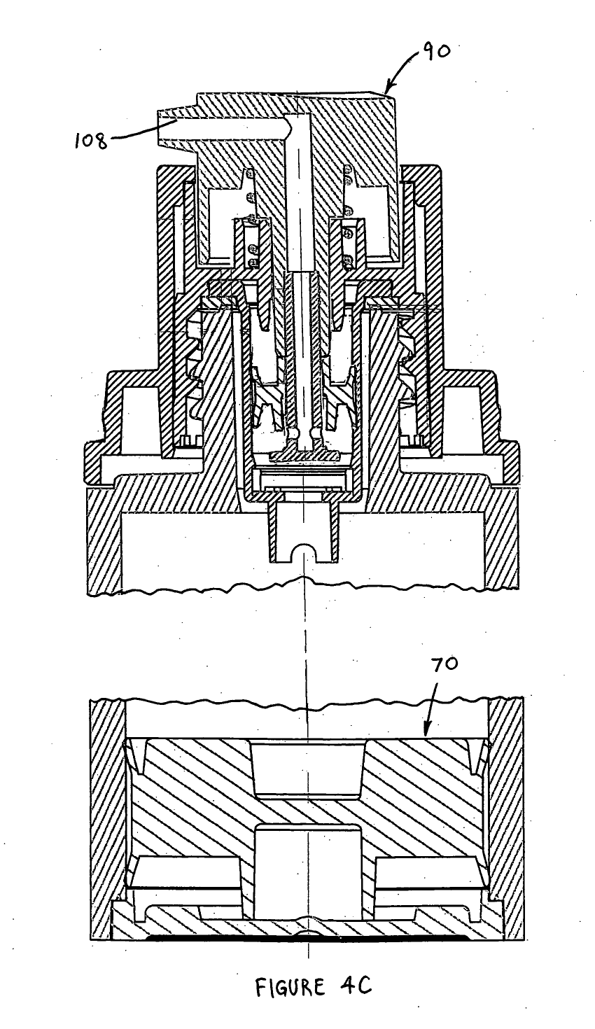

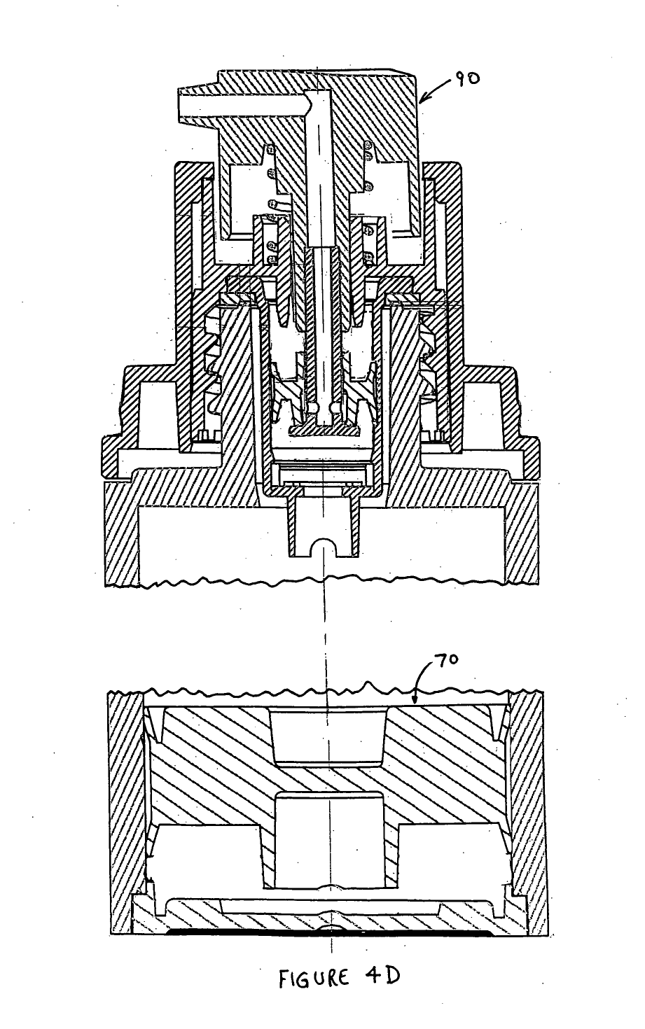

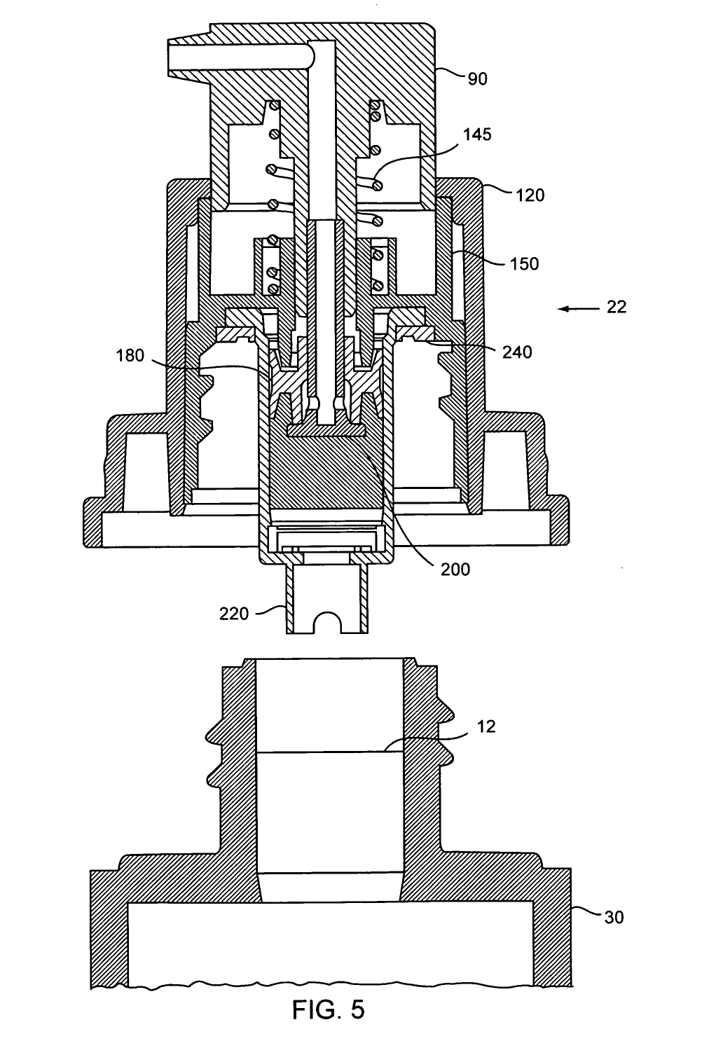

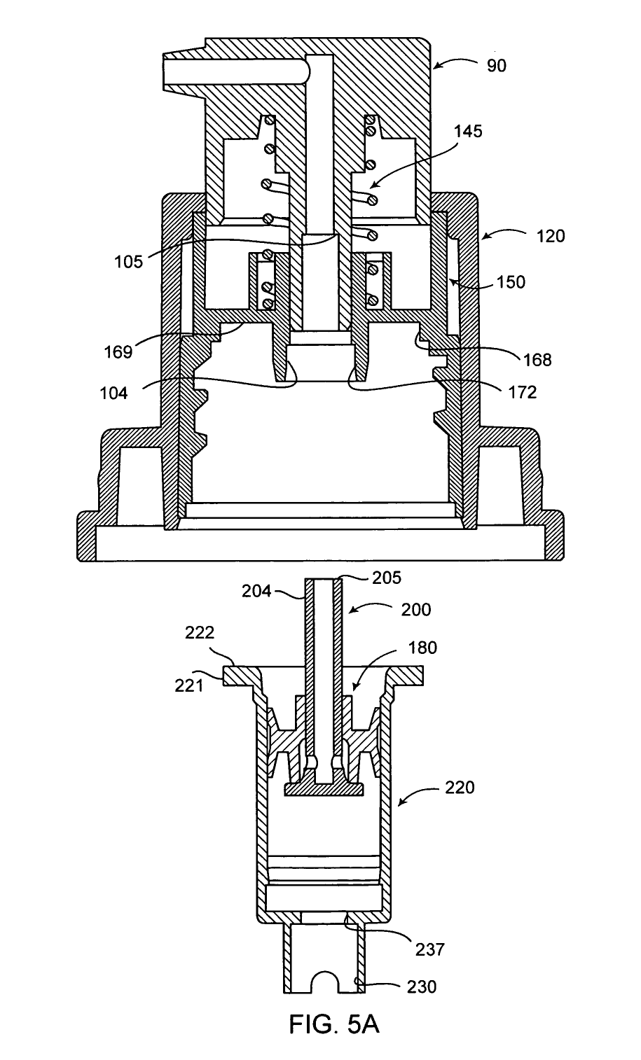

FIG. 1 shows a first embodiment of the cosmetic spray bottle assembly 10, which is comprised of the cap 15, which may be advanced toward and snapped over the spray bottle cylinder with airless pump 20, as shown in FIG. 2, to prevent unintended dispensing of product through incidental contact with the nozzle head. FIG. 4A shows an enlarged view of the upper and lower ends of the bottle cylinder with the airless pump, and the pump assembly 22 is shown detached from the bottle cylinder assembly 24 in FIG. 5. The component parts of the entire airless pump 20 are shown in the exploded view of FIG. 6 to help illustrate the assembly and operation of the device of the present invention. Those component parts include bottle cylinder 30, a volume adjustment piston 70, bottle plug 50, nozzle head 90, nozzle casing 120, head biasing spring 145, valve housing 150, valve seat piston 180, valve spool 200, valve inlet sleeve 220, and bottle sealing member 240. From studying the figures and disclosure herein, it should be understood that the nozzle casing 120, the valve housing 150, and the valve inlet sleeve 220 may alternatively be manufactured to be a single “housing” part that incorporates all of the functional features of those three individual components; however, all three component parts are preferably utilized for ease of manufacturing of the pump 22. Similarly, it is also possible to construct the device whereby the nozzle head 90 and the valve spool 200 are manufactured as a single part, but this would require a different design for the combined parts and would undesirably entail a more complex assembly process, particularly with respect to the valve seat piston 180.

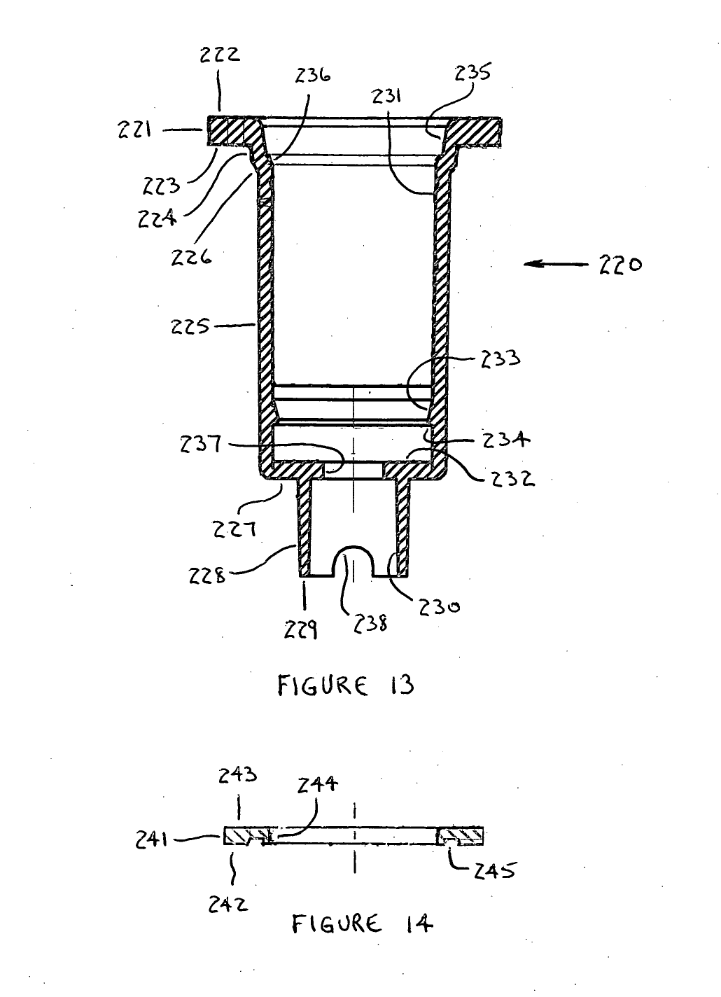

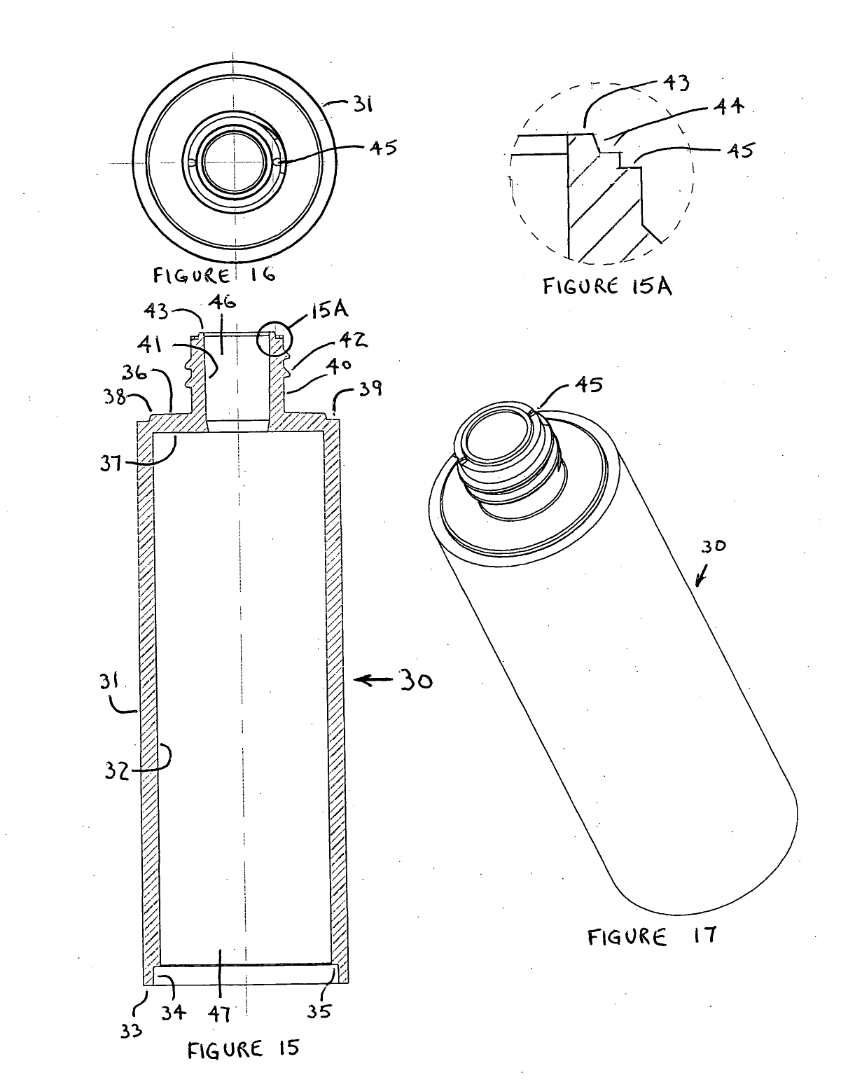

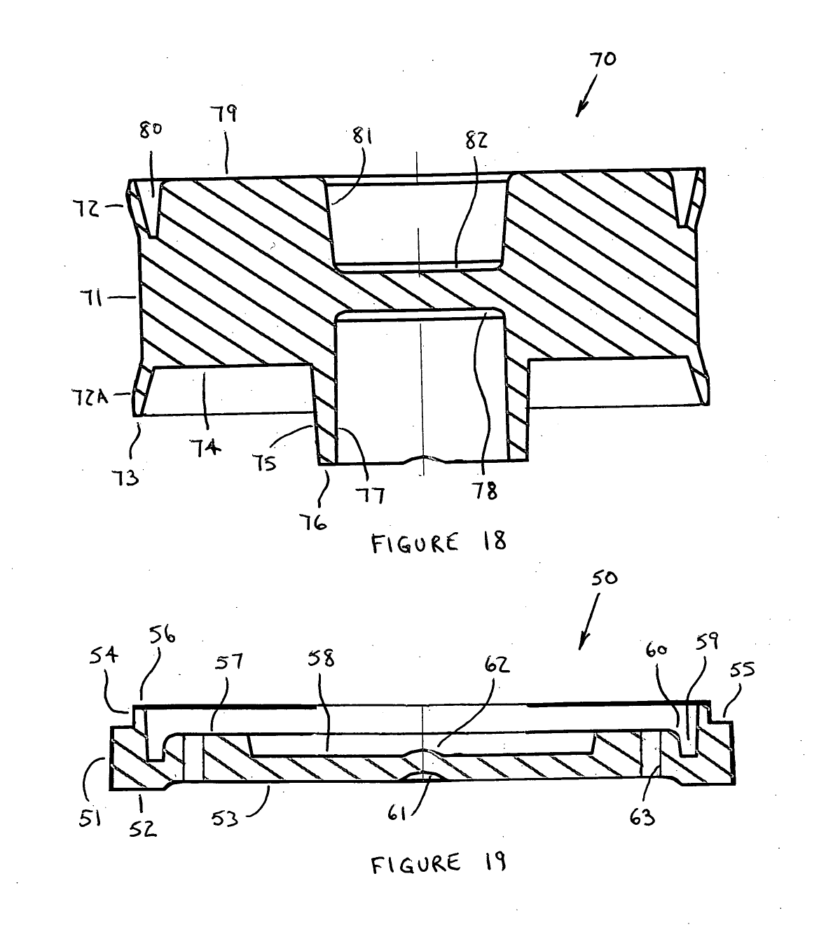

The bottle cylinder assembly 24 may be comprised of the bottle cylinder 30, bottle plug 50, and piston 70. Enlarged views of the bottle cylinder 30 are shown in FIGS. 15, 15A and 16-17. The bottle cylinder 30 may be formed of any suitable material, including, but not limited to, glass and plastic. The bottle cylinder 30 may be comprised of a generally tubular section formed by cylindrical outer surface 31, and a cylindrical inner surface 32, both of which may terminate on bottom end surface 33. The lower end of bottle cylinder 30 may have a stepped inner surface 34, and a bottom shoulder 35 that connects with cylindrical inner surface 32 to create an opening 47.

The upper end of the bottle cylinder 30 may be closed off with top end outer surface 36 and corresponding top end inner surface 37. The top end outer surface may have a radiused edge 38 that transitions to a top end step 39. Extending upward from top end outer surface 36 may be a spout formed by a spout outer surface 40 and a spout inner surface 41. The spout outer surface 40 may have external threading 42 across a portion thereof. The spout outer surface 40 and spout inner surface 41 may terminate at the spout end surface 43. To assist in sealing the bottle cylinder 30 within the pump assembly 22, as will be discussed later, the spout end surface 43 may have an annular step 44. The annular step may also have a pair of notches 45, as shown in FIGS. 15A and 17, which may receive a tool to prevent rotation of the bottle cylinder 30 during assembly. The spout of bottle cylinder 30 may thus have a top opening 46, in addition to the bottom opening 47. The bottom opening 47 of bottle cylinder 30 may preferably be sealed using the bottle plug 50 of FIG. 19 after the piston 70 of FIG. 18 has been therein installed.

The volume adjustment piston 70 may be comprised of a cylindrical member formed by outer cylindrical surface 71. The outer cylindrical surface 71 may have an annular protrusion 72 on its upper end and annular protrusion 72A on its lower end. The lower end of piston 70 may be defined by bottom end surface 73, while the upper end may be defined by top end surface 79. To permit the annular protrusions 72 and 72A to have flexure capability to provide for sealing against the bottle cylinder inner surface 32, a relief groove 80 may be provided so as to pierce top end surface 79, and a recess 74 may be provided in bottom end surface 73. Extending downward from recess 74 may be cylindrical extension 75 which may be concentric to outer cylindrical surface 71, and which may terminate in bottom surface 76. The cylindrical extension 75 may have an orifice 77 with a bottom surface 78. The top end surface 79 may similarly have an orifice 81 concentrically located with respect to outer cylindrical surface 71, and having a bottom surface 82, which may serve to assist in the pumping of product once most of the product has already been pumped from the bottle (see FIG. 4A, where cylindrical extension 228 of the valve inlet sleeve 220, discussed hereinafter, is eventually received within orifice 81).

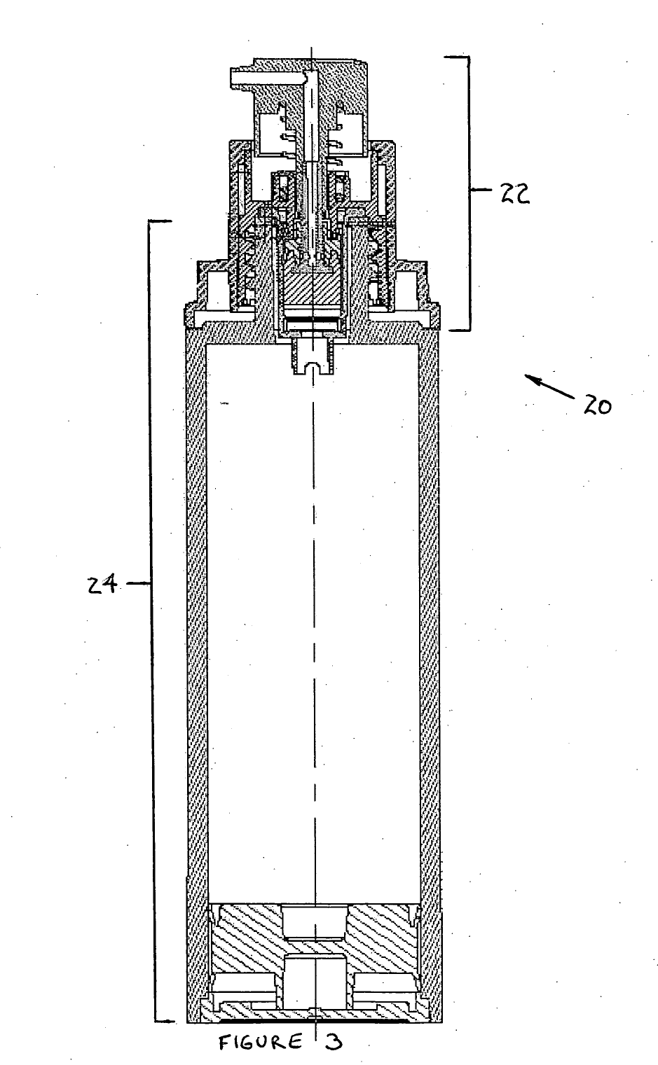

The piston 70 shown in FIG. 6 may be installed into the bottle cylinder 30 by depressing the flexible annular protrusion 72 at the top end surface 79 and inserting the piston so that the protrusion 72 contacts the cylindrical inner surface 32. Continued insertion of the piston 70 into the bottle cylinder 30 results in the flexible annular protrusion 72A at the bottom end surface 73 being depressed, as it contacts the cylindrical inner surface 32. Both of the flexible annular protrusions 72 and 72A, as seen in FIG. 3, may serve to seal the lower end of the bottle cylinder 30 and act as slidable barrier to leakage of a cosmetic product out of the bottom.

The sliding capability of the piston 70 within the bottle cylinder 30 and its proper functioning in preventing leakage may both be advantageously promoted by selectively choosing materials for the bottle and for the piston that reduces the frictional coefficient therebetween, as well as appropriate design for the height of the protrusions 72/72A and the relief provided by groove 80 and recess 74. The protrusion height and the amount of relief may calibrated so that the protrusions may be biased against the cylinder inner surface 32 to prevent leakage, but not be so stiff and compressed therein as to provide a large normal force that would nonetheless provide a high resisting force despite a low coefficient of friction. The friction force resisting movement, F_{f}, being determined from the equation, F_{f}=μ·Fₙ, where Fₙ is the normal force provided by the protrusions 72, and μ is the coefficient of friction between the two materials.

Once the piston 70 has been inserted into the bottle cylinder 30, the bottle plug 50 may be installed into the lower end of the bottle cylinder. In one embodiment, the bottle plug 50 may be therein installed so as to merely provide a restraint on the movement of the piston out from the bottom end of the bottle cylinder 30, but conversely may permit sliding movement of the piston 70 towards the top end inner surface 37 of the cylinder bottle. The bottle plug 50 may have one or more openings, such as orifice 63, which allows air to enter in between the piston 70 and bottle plug 50, to prevent a vacuum lock from being created therein between the two parts. A vacuum created therein would inhibit movement of the piston 70, and counter the pump action elicited by the remainder of the invention. In another embodiment, instead of using the bottle plug 50 to retain the piston 70 within the bottle 30, the cylinder inner surface 32 may contain protrusions or stops that prevent it from sliding out the bottom opening 47, once properly installed therein.

As seen in FIG. 19, the bottle plug 50 may have a cylindrical outer surface 51, a bottom surface 52, and a top surface 56. The bottom surface 52 may be interrupted by a recess 53. The outer surface 51 may be stepped to create a shoulder 55 and a peripheral surface 54, which may have a diameter somewhat less than that of the inner surface 32 of bottle cylinder 30. The top surface 56 may have a recess creating inner surface 57, which may transition at its periphery into an annular groove 59 via radius 60. Inner surface 57 may itself have a recess creating a nested inner surface 58, which may be concentric to outer surface 51. The recessed surface 53 may have an indentation 61, which creates a dimple 62 on nested inner surface 58.

The outer surface 51 of plug 50 may be connected to the stepped inner surface 34 of bottle cylinder 30. The connection may be provided through internal and external threading present on the respective mating surfaces, or it may also be provided by gluing or bonding of the parts together in a more permanent arrangement. Alternatively, the plug 50 may be connected to the stepped inner surface 34 of bottle cylinder 30 by way of a friction fit. The outer surface 51 of plug 50 may be slightly oversized relative to the stepped inner surface 34 of bottle cylinder 30, and their assembly may be accomplished using a press-fit means of installation, or a cryogenic shrink-fit means. Such installation of the plug into the bottle cylinder should occur until the shoulder 55 of plug 50 contacts bottom shoulder 35 of the bottle cylinder 30 (FIG. 3). Either installation means should result in normal forces between the outer surface 51 of plug 50 and the stepped inner surface 34 of bottle cylinder 30, with retention of the plug 50 therein.

The pump assembly 22 of the present invention, shown in FIG. 5, comprises a sequenced assembly of the remaining component parts, namely, nozzle head 90, nozzle casing 120, head biasing spring 145, valve housing 150, valve seat piston 180, valve spool 200, valve inlet sleeve 220, and bottle sealing member 240. The assembly is illustrated on the left-hand side of FIG. 6. Each of the parts may be constructed of any suitable material, including, but not limited to, metal, plastic, and phenolic resins.

The nozzle head 90, enlarged in FIG. 7, may be generally cylindrical, being formed with cylindrical outer surface 91, and with a top end 92 that may be flat or contoured to better accommodate gripping by a single finger. The cylindrical surface 91 may terminate at bottom surface 93. Bottom surface 93 may have an annular opening 94 with an inner surface 95. Protruding down from inner surface 95 may be extension 96 which may be cylindrical or may alternatively have the slight conical shape shown in FIG. 7, and which may terminate at surface 99. Timer surface 95 may have an annular notch 97, which may serve to positively retain one end of head biasing spring 145. Protruding downward from surface 99 of extension 96 may be a cylindrical extension 98 which may terminate at end surface 100, and have a chamfered edge 101.

Formed within nozzle head 90 may be a first chamber 102 that may preferably be cylindrically shaped and be concentric to cylindrical extension 98. First chamber 102 may be bored or be formed as part of a casting process or any other suitable manufacturing process to enable its construction. The first chamber 102 may preferably terminate near top end 92 at an end wall 103. A second cylindrical chamber 104 may also be formed within nozzle head 90, and may preferably be concentric to first chamber 102, but with a slightly larger diameter. The second cylindrical chamber 104 may begin as inlet opening 104A at end surface 100, and may only penetrate to a depth that is a portion of the depth of first chamber 102. Therefore, second cylindrical chamber 104 may terminate to create a shoulder 105.

Protruding radially outward from cylindrical outer surface 91 of nozzle head 90 may be a conical extension 106 having an end surface 107. A third chamber 108 may begin as a delivery opening 108A in surface 107 of the conical extension 106, and may have sufficient depth so as to join and interconnect with first chamber 102. The cylindrical chamber 102 and 108 may both serve as conduits for the flow of a cosmetic product, once pumping action has commenced, as hereinafter described.

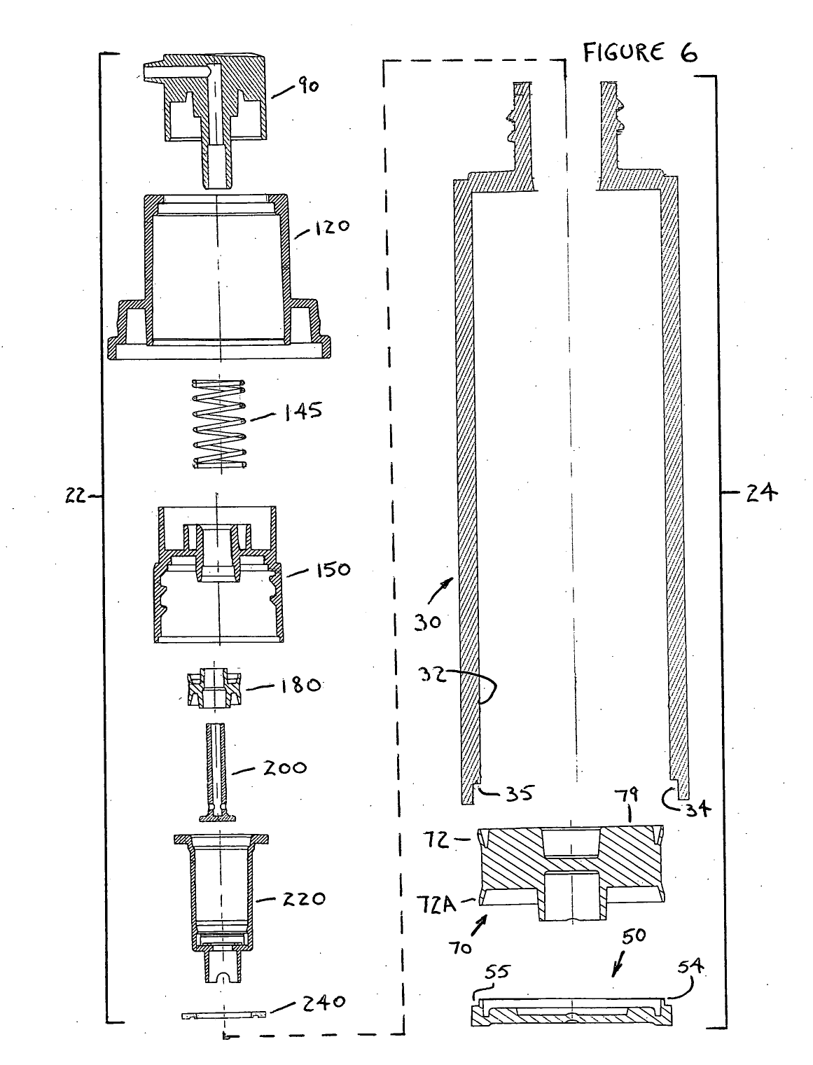

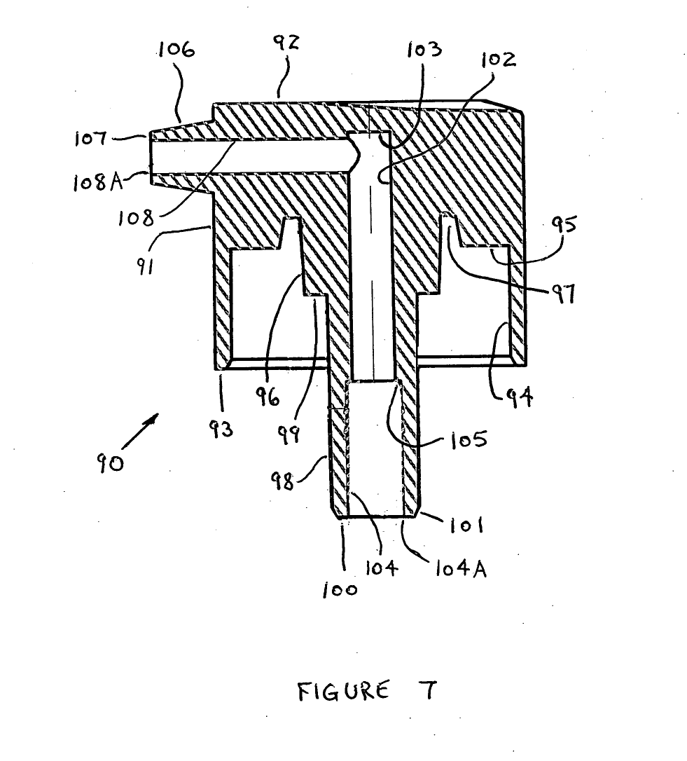

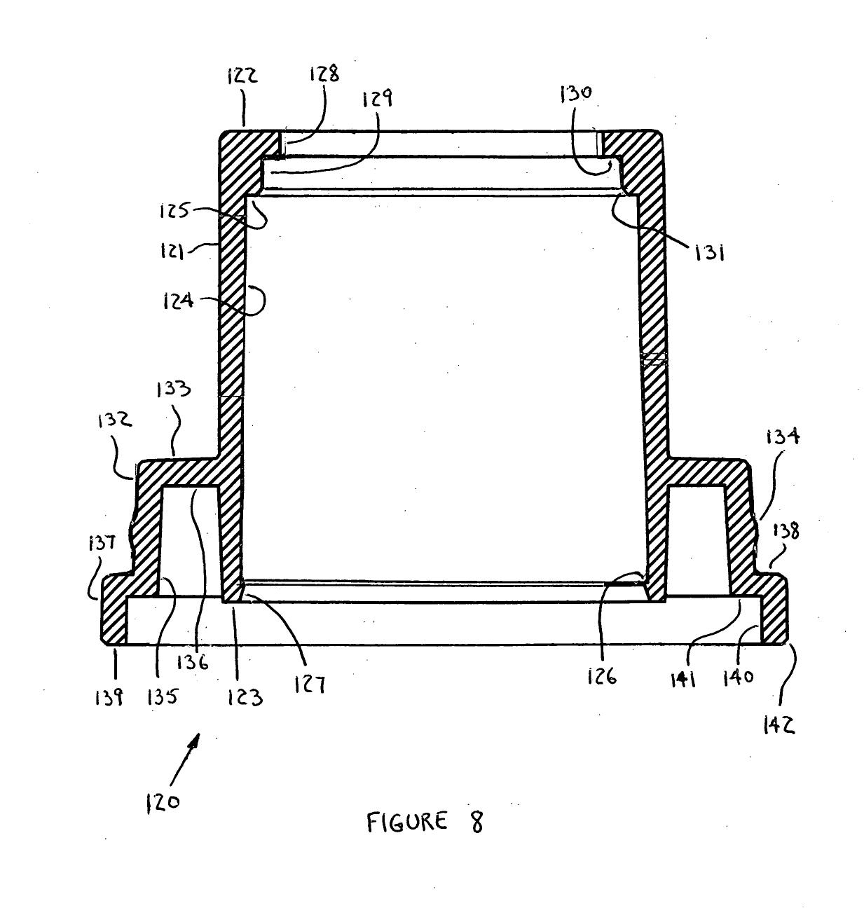

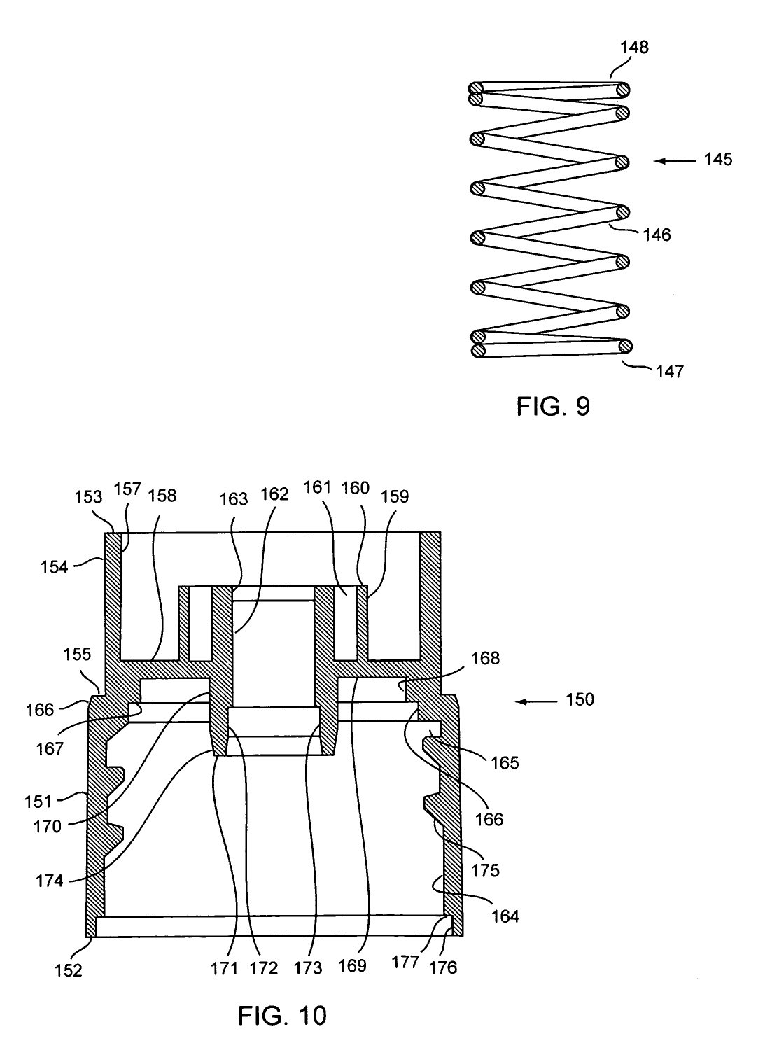

The nozzle casing 120 (FIG. 8) may be comprised of an outer cylindrical surface 121 which has a top end surface 122 and a bottom end surface 123. The nozzle casing 120 may have an inner cylindrical opening 124, which may span from inner end surface 125 to lip 126. Lip 126 may be formed with a conical opening 127 at bottom end 123. The top end surface 122 may have an orifice 128 that connects to inner cylindrical opening 124. Orifice 128 may be sized to permit cylindrical surface 91 of nozzle head 90 to be slidably received therein. An annular opening 129 in nozzle casing 120 may create a shoulder 130. There may be a chamfer 131 at the meeting of annular opening 129 and inner end surface 125.

Nozzle casing 120 may also be comprised of conical extension 132 that may begin at a location above bottom end surface 123 of outer cylindrical surface 121, and preferably begins at surface 133 and terminates at bottom end 140. Conical extension 132 may have an annular protrusion 134. The conical extension 132 and annular protrusion 134 may be included in nozzle casing 120 in order to be able to receive the annular indentation 17 of inner wall 16 of cap 15 (FIG. 2) to thus have a means to secure the cap 15 to the nozzle assembly 22. Conical extension 132 may have an annular opening 135 with a depth to surface 136, with the opening providing some flexibility to extension 132 to better allow the cap 15 to snap thereon. Protruding downward from the conical extension 132 may be a cylindrical extension shroud 137, which may begin at surface 138 and terminate at surface 139. The cylindrical extension 137 may have a hollowed interior because of an annular opening 140, which may have a depth up to surface 141 to expose the bottom end 123 of the outer cylindrical surface 121. A chamfer 141 may be used at the intersection of cylindrical extension 137 and surface 139.

The diameter of orifice 128 of the nozzle casing 120 should be sufficient to provide a clearance fit with the cylindrical outer surface 91 of nozzle head 90. The nozzle head 90 may be interconnected with another component of the pump assembly 22 as hereinafter discussed.

The valve housing 150 (FIG. 10) may have a lower cylindrical outer surface 151 and an upper cylindrical outer surface 154 of a lesser diameter, where the lower outer cylindrical surface 151 is connected to the upper cylindrical outer surface 154 by a shoulder step 155, which may be chamfered using chamfer 156. Upper outer cylindrical surface 154 may extend upward to top end 153, and lower cylindrical outer surface 151 may extend downward to bottom end surface 152. An annular opening 157 in the upper cylinder 154 may extend downward to wall 158. Protruding upward from wall top surface 158 may be cylinder 159, which may be formed concentric to cylinder 154 and may protrude up until reaching surface 160.

Cylinder 159 may have an annular recess 161 and an orifice 162, both of which may also be formed concentric to cylinder 154. The orifice 162 opening may have a chamfer 163 for permitting ease of installation therein of the cylindrical extension 98 of nozzle head 90, with the nozzle head's chamfered edge 101 also assisting in centering the extension during its installation. The recess 161 may be sized to receive the second end of head biasing spring 145, which, as seen in FIG. 5, would serve to bias the nozzle head 90 relative to valve housing 150.

The lower cylinder 151 of the valve housing 150 may have an annular opening 168 which rises up to wall bottom surface 169. Protruding downward from wall surface 169 may be cylinder 170, which may be concentric to cylinder 159, and which may terminate at end surface 171. The meeting of cylinder surface 170 and end surface 171 may have a chamfer 174. The cylinder 170 may have an orifice 172 concentric with orifice 162, but only of sufficient depth to create shoulder 173. The lower cylinder 151 may also have annular opening 168 step to a larger annular opening 166, creating shoulder 167, and then step again to an even larger annular opening 164, which creates shoulder 165. The annular opening 164 may stretch for most of the depth of the lower cylinder 151, and be contained for at least a portion thereon may be internal threading 175. The lower cylinder 151 may also have a shallow annular opening 176 near bottom end surface 152 that creates shoulder 177.

Since the valve housing 150 is to be received within the nozzle casing 120, as seen in FIGS. 5-6, and the upper portion of FIG. 5A, the upper outer cylindrical surface 154 of valve housing 150 may be sized for either a clearance fit or a interference fit with the corresponding diameter of annular opening 129 in nozzle casing 120. The lower cylindrical outer surface 151 of the valve housing 150 may have a similar fit with the corresponding diameter of annular opening 124 in nozzle casing 120. The valve housing 150 may be retained within the nozzle casing 120 through either a friction fit, or by a press-fit or cryogenic shrink-fit installation whereby the top end 153 of valve housing 150 is restrained from translating vertically upward by shoulder 130 of nozzle casing 120, and the bottom end 152 is restrained from translating vertically downward by lip 126 of the nozzle casing. The top end 146 of head biasing spring 145 may slide over conical extension 96 to retained within annular notch 97 of nozzle head 90, and the bottom end 147 of head biasing spring 145 may slide into the annular recess 161 of cylinder 159 of the valve housing 150 (FIG. 5A). The head biasing spring 145, as shown in the sub-assembly of FIG. 5A, is in a compressed state, and would therefore tend to freely bias the as yet unrestrained nozzle head 90 upward from its normal position. Once the shaft 204 of valve spool 200 is installed into the nozzle head 90, as discussed later, the nozzle head 90 of FIG. 5A could be depressed to move downward, only to be biased upward to the shown rest position, which also may be referred to as its first position.

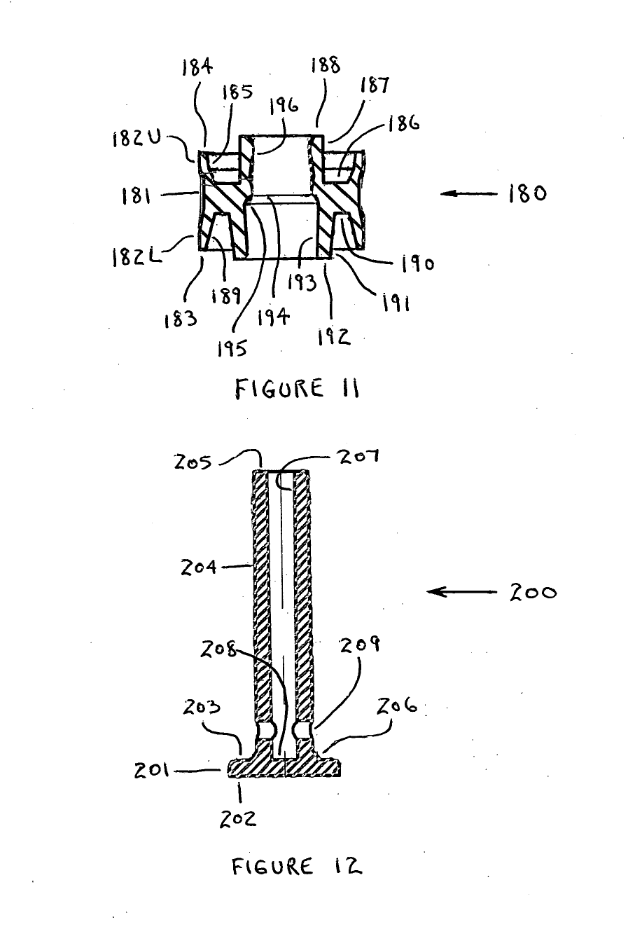

Valve spool 200 (FIG. 12) may have a head formed by a cylindrical outer surface 201, a bottom displacing surface 202, and a top sealing surface 203. Extending upward from top sealing surface 203 may be a cylindrical shaft 204, which terminates at shaft top end 205. The cylindrical shaft 204 is to be permanently affixed, at the appropriate point of the assembly sequence, within the chamber 104 of nozzle head 90, and should be sized to fit therein. The fit may be a close sliding clearance fit, if the parts are to be bonded together, or may be an interference fit (friction fit) whereby the diameter of the shaft 104 may be slightly larger than the diameter of chamber 104 of nozzle head 90, with the parts assembled together in a press-fit operation or through a cryogenic installation.

The shaft 204 may join top sealing surface 203 using either an angled or a filleted surface 206. The shaft 204 may have a chamber 207 located therein, which may be bored from shaft top end 205 or be formed as part of a casting process or other manufacturing means. Chamber 207 may preferably be concentric to cylindrical shaft 204 and may terminate at chamber end 208, which may be co-planar with top sealing surface 203. Shaft 204 may also have one or more orifices oriented cross-wise to the axis of cylindrical shaft 204. In a preferred embodiment, there may be at least a pair of in-line orifices 209. Having three or more orifices being regularly spaced around the periphery of the cylindrical shaft 204 may serve to prevent an air bubble within the cosmetic formula from clogging the pump.

Valve seat piston 180 (FIG. 11) may resemble, somewhat, the volume adjustment piston 70 in its form, and actually serves a complementary function, as will be discussed later in the description of the double-action nature of the dispensing device. Valve seat piston 180 may have a cylindrical outer surface 181 with a bottom end surface 183 and a top end surface 184. The cylindrical outer surface 181 may have an upper annular protrusion 182U, and a lower annular protrusion 182L. The top end surface 184 may have an annular opening 185 down to a depth at surface 186. Protruding upward from surface 186 of annular opening 185 may be an extension, which may preferably be a cylindrical extension 187 that terminates at top surface 188. An orifice 196 may be located in cylindrical extension 187 to be concentric to cylindrical extension 187. The bottom end surface 182 may have an annular opening 189 up to a depth at surface 190. Protruding downward from surface 190 of annular opening 189 may be an extension, which may be a conical extension 191 that terminates at bottom surface 192. Conical extension 191 may have a conical opening 193 to a depth shown by the run-out of radius 195 with the orifice 196 to create the edge 194.

Since the valve seat piston 180 is intended to receive a portion of the shaft 204 of the valve spool 200 in a sliding clearance fit, the orifice 196 may preferably be slightly larger than the diameter of cylindrical shaft 204 of the valve spool 200. Also, since the top sealing surface 203 of valve spool 200 is devised to seal the conical opening 193 of the valve seat at bottom surface 192, the cylindrical outer surface 201 of the valve spool 200 may necessarily be larger than the conical extension 191 at bottom surface 192, and also the meeting of conical opening 193 at bottom surface 192 may necessarily be of a sufficient size to clear the filleted surface 206 of valve spool 200.

The valve inlet sleeve 220 (FIG. 13) may be comprised of an outer cylindrical surface 221 having a top end surface 222 and a bottom end surface 223. A first cylindrical extension 224 may protrude downward minimally from bottom end surface 223, and which may transition, via angled surface 226, to a second cylindrical extension 225. The second cylindrical extension 225 may extend downward to a bottom end 227. A third cylindrical extension 228 may protrude downward from bottom end 227 of the second cylindrical extension 225 to bottom 229. The bottom 229 of the third cylindrical extension 228 may have an annular opening 230 down to a depth which may preferably coincide with bottom end 227 of the second cylindrical extension 225. There may also be a side opening 238 in the third cylindrical extension 228, which may resemble a half-race-track shape, and which is significant in pumping the remaining volume of cosmetic liquid contained in the bottle assembly.

There may also be an annular opening 231 beginning at top end surface 222 and being concentric to second cylindrical extension 225. The annular opening 231 may be down to a depth shown by surface 232, leaving a wall between the respective bottom surfaces of the openings of the second cylindrical extension 225 and the third cylindrical extension 228, which may be interconnected by orifice 237. The annular opening 231 may be interrupted at a location proximate to surface 232 by a ramped protrusion 233, which creates a shoulder 234. The ramped protrusion 233 separating the annular opening 231 may thus necessitate that the annular opening 231 not be formed by a boring operation, and alternatively be formed by turning on a lathe, or as part of a casting or other manufacturing process. The top end surface 222 may be further opened by having a first conical opening 235, which may transition to a more steeply pitched conical opening 236 that may connect to the annular opening 231.

The dimensions of the valve inlet sleeve 220, particularly the annular opening 231, may be sized, both as to diameter and length, to generously accommodate the shaft 204 of valve spool 200 and its stroke. The annular opening 231 and wall surface 232 essentially creates a volume that may serve as a reservoir for the pump, the action of which is described hereinafter. Having a significantly larger ratio of reservoir volume to bottle volume may serve to permit a larger dose of delivered formula per pump stroke, as seen hereinafter, but the amount of product delivered per stroke may need to be selected for each type of product that is to be delivered. In addition, with the proper sizing and number or orifices 209 in the periphery of the cylindrical shaft 204, and appropriate sizing of the chambers 102 and 108 in the nozzle head 90 and chamber 207 in the valve spool 200, the pump arrangement may permit delivery of a cosmetic formula having a higher viscosity. As illustrated, the design may allow for proper delivery of product having viscosity in the range of approximately 1,500-40,000 cps, whereas other pumps can typically handle viscosity ranges of about 2,000-15,000 cps.

As seen in the lower portion of FIG. 5A (and FIGS. 11-12), the shaft 204 of valve spool 200 may be slidably disposed within orifice 196 of the valve seat piston 180 such that the top sealing surface 203 of the valve spool 200 may contact bottom end surface 183 of the valve seat piston 180. Thereafter, the valve spool 200 and valve seat piston 180, being so assembled, may then be slidably disposed within the valve inlet sleeve 220, such that the upper and lower annular protrusions 182U and 182L may be slidably received within the annular opening 231 of the valve inlet sleeve 220. This sub-assembly of the valve inlet sleeve 220, the valve seat piston 180 and the valve spool 200 (lower portion of FIG. 5A) may then be mated with the subassembly of the upper portion of FIG. 5A as follows.

The outer cylindrical surface 221 of valve inlet sleeve 220 may be sized so that the valve inlet sleeve 220 can be installed into the valve housing 150 (FIGS. 5 and 5A) with top end surface 222 of the valve inlet sleeve contacting wall bottom surface 169 of valve housing 150, and with the outer cylindrical surface 221 contacting or merely being proximate to annular opening 168 of the valve housing. The connection therebetween may be a friction fit, or it may be accomplished using adhesive, epoxy, or some other bonding agent.

While the valve inlet sleeve 220 is being mated with valve housing 150, the shaft 204 of the valve spool 200 must be fed through the orifice 172 of cylinder 170 of the valve housing 150, and into the second cylindrical chamber 104 of the nozzle head 90. It must be fed therein until the shaft top end 205 of the valve spool 200 contacts the shoulder 105 of the nozzle head 90. The arrangement, as with other insertions previously described, may be in the nature of a friction fit or a glued/bonded arrangement. Since, as may be seen in FIG. 5A, the length of the valve spool 200 is such that it may initially be withdrawn entirely into the valve inlet sleeve 220, the process of mating its shaft 204 within chamber 104 of nozzle head 90 may be assisted by inserting a tool through the annular opening 230 and orifice 237 of the valve inlet sleeve to force its engagement therein. Another possible assembly sequence may have the head biasing spring 145 and nozzle head 90 be alternatively installed into the nozzle casing 120 and valve housing 150, after the valve inlet sleeve 220, valve seat piston 180, and valve spool 204 have been installed into the valve housing 150.

The above assembly process results in the pump assembly 22 of FIG. 5, except for installation of the bottle sealing member 240. Bottle sealing member 240 may preferably be formed of a pliable material so that it may serve as a gasket and seal the top 43 of the bottle 30 of the bottle assembly 24, when the pump assembly 22 is screwed onto the bottle (FIG. 4A). The material for bottle sealing member 240 may include, but is not limited to, gasket paper, rubber, silicone, metal, cork, felt, neoprene, nitrile rubber, fiberglass, or a plastic polymer (such as polychlorotrifluoroethylene). The bottle sealing member 240 (FIG. 14) may simply be an annular ring having an outer cylindrical surface 241, a bottom end surface 242, a top end surface 243, and an orifice 244 to thus resemble a plain washer. The bottle sealing member 240 may also include a rectangular notch 245 being shaped and sized to receive the top end 43 of the bottle cylinder 30. However, notch 245 may not be a permanent feature and may only be formed in the bottle sealing member 240 as a temporary indentation resulting from contact with the top end 43 of the bottle cylinder 30 when the pump assembly 22 is firmly screwed onto the bottle assembly 24 (FIGS. 3-4).

The bottle sealing member 240 may be installed to form the completed pump assembly 22 by gluing/bonding it in place, whereby the top surface 243 of bottle sealing member 240 contacts the bottom end surface 223 of the valve inlet sleeve 220 and also overlays the shoulder 167 of the valve housing 150. Because of the pliable nature of the bottle sealing member 240, a friction fit installation whereby its outer cylindrical surface 241 engages the annular opening 166 of the valve housing 150 will not be preferable, unless the periphery and other portion of the bottle sealing member are otherwise hardened.

Operation of the combination double-piston double-action pump and cosmetic bottle dispensing device 10 disclosed herein may be understood by an examination and discussion of FIGS. 4A-4D. With the bottle assembly 24 completed as described and filled with a cosmetic substance 12—a liquid or a more viscous semi-liquid—the pump assembly 22 may be screwed thereon such that the internal threading 175 of the valve housing 150 engages the external threading 42 of bottle cylinder 30. A slight amount of the cosmetic substance 12 may overflow, or alternatively, the bottle may be filled with an amount to be slightly less than full (FIG. 5), with that amount perhaps being based upon the volume of cosmetic substance that may be displaced by the valve inlet sleeve 220 being inserted therein. The arrangement should be torqued sufficiently to have the bottle spout end surface 43 nestle securely into the bottle sealing member 240, and thereby prevent any air from entering into, or cosmetic substance leaking out from the bottle. The shroud 137 of the nozzle casing 120 may then be proximate to the top end step 39 of the bottle cylinder 30. It should be noted that some pumping action, as hereinafter described, may be needed to eliminate any initial air pocket in the bottle, before the cosmetic substance 12 may reach a level that permits it to be dispensed.

The nozzle head 90 and valve spool 200 may initially occupy a first position (FIG. 4A) that may also be referred to as a primed position, in that the nozzle head may typically be therein ready to deliver cosmetic substance when actuated by the user. Depressing the nozzle head 90 may produce a down stroke, which, as seen from FIGS. 4A and 4D, may eventually be limited by the bottom 93 of the nozzle head 90 contacting the wall top surface 158 of the valve housing 150, and/or may alternatively be limited by the shoulder 99 of the nozzle head 90 contacting surface 160 of the valve housing 150. The initial part of the down stroke of the nozzle head 90 may cause the compression of helical spring 145, and may also cause the valve spool 200, being connected to the nozzle head, to similarly translate downward. This initial downward translation of the valve spool may be relative to the valve seat piston 180, and may thus cause the in-line orifices 209 on the shaft 204 to move to a position beyond the bottom surface 192 of the piston 180, to thereby expose the orifices to the cosmetic substance 12 in reservoir 23.

As the down stroke of the nozzle head/valve spool combination progresses, it reaches a second position at which the end surface 100 of cylindrical extension 98 of the nozzle head 90 may engage the top 188 of cylindrical extension 187 of the valve seat piston 180 (see FIG. 4B). This contact, as the down stoke continues, then results in the nozzle head 90 driving the valve seat piston 180 into the cosmetics substance 12 contained within the reservoir 23. The cosmetic substance 12, whether a liquid or semi-liquid, is essentially incompressible, and the volume decrease caused by such downward movement of the valve seat piston 180 and spool 200 creates pressure that must be accommodated, resulting in pumping of the substance from the reservoir. While it is possible for this pressure to cause the bottle piston 70 to be forced downward (after it has been raised away from the plug 50), a sufficient amount of biasing between the annular protrusions 72 and 72A of the bottle piston 70 with the bottle 30 may counteract this downward force, and instead, a lesser resistance to the pressure may be provided by fluid flow of the cosmetic substance through the orifices 209 and chamber 207 of the valve spool 200, and through the chambers 102 and 108 and out the conical extension 106 of nozzle head 90, to result in dispensing of the substance out from the reservoir 23 and bottle 30.

Once the nozzle head 90 and valve spool 200 have completed the down stoke to occupy a third position, illustrated in FIG. 4C, the user may cease applying the downward force to the top end 92 of the nozzle head 90. Upon removal of the downward force, the spring 145 may then freely bias the connected nozzle head and spool upward during the up stroke. As the spring begins to bias the nozzle head 90 upward, it will first cause the nozzle head 90 and valve spool 200 combination to disengage from top surface 188 of the valve seat piston 180 and translate a short distance upward, relative to the valve seat piston, to occupy a fourth position where the top sealing surface 203 of the valve spool 200 once again contacts the bottom 192 of cylindrical extension 191 of the valve seat piston (FIG. 4D). This initial upward motion may cause a very small amount of cosmetic substance to return from the chamber 207 of the valve spool 200 to the reservoir 23, until the valve spool 200 is seated against the piston 180, at which time the orifices 209 of the valve spool 200 are sealed and are no longer exposed to the cosmetic substance 12. When the orifices 209 of the valve spool 200 are no longer exposed to the cosmetic substance 12 within reservoir 23, the remaining store of cosmetic substance 12 is then sealed between the valve spool 200/valve seat piston 180 combination, and the bottle piston 70.

Continued upward biasing of the nozzle head 90 and valve spool 200 by the spring 145 will also now cause upward biasing of the valve seat piston 180. This upward movement would normally create an increase in the volume of the reservoir and bottle, but since the substance occupies a sealed system in which the reservoir 23 and the interior of the bottle 30 are interconnected by the orifice 237 in the valve inlet sleeve 220, and the cosmetic substance within the bottle is essentially incompressible, the upward movement tends to create vacuum pressure within the reservoir 23 and bottle 30. Rather than permitting air to enter the sealed system, which would degrade the integrity of the cosmetic substance therein, the vacuum pressure instead produces a corresponding secondary action—the upward movement of the bottle piston 70 and the cosmetic substance immediately above it. Thus, the vacuum pressure must overcome the loose friction fit between the bottle piston 70 and the inner surface 32 of bottle 30, which must nonetheless be sufficient to prevent downward translation during the down stroke, as previously discussed. Since the reservoir 23 and the interior of the bottle 30 are interconnected by the orifice 237 in the valve inlet sleeve 220, this upward movement of the bottle piston 70 causes the reservoir 23 to again be filled with the cosmetic substance 12. This upward movement is possible as long as the biasing provided by spring 145 is calibrated to supply a force that is at least greater than the sum of the frictional force between the bottle piston 70 and bottle 30, and the weight of both the cosmetic substance 12 and bottle piston 70. As previously noted, upward movement of the bottle piston 70 away from the bottle plug 50 is achievable because orifices 63 in the bottle plug prevent a vacuum lock from being formed therebetween.

Once most of the cosmetics substance 12 has been pumped from the device 10, the top end surface 79 of the bottle piston 70 may then approach and eventually contact the top end inner surface 37 of the bottle cylinder 30 (FIG. 4A), and the third cylindrical extension 228 of the valve inlet sleeve 220 may then be positioned within the orifice 81 of the bottle piston 70. This arrangement serves to enable the device 10 to better pump a small remaining cosmetic substance, and not leave significant quantities repetitively trapped in the bottle 30. Once the bottom surface 76 of the third cylindrical extension 228 of the valve inlet sleeve 220 contacts the bottom surface 82 of the orifice 81 of the bottle piston 70, continued pumping of any cosmetic substance 12 in the orifice may be facilitated by the half-race-track shaped opening 238 in the side of the third cylindrical extension 228 of the valve inlet sleeve 220.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

We claim:

1. An airless double-piston double-action dispensing device comprising:
a bottle, said bottle comprising a sidewall having a top opening and a bottom opening;
a bottle piston, said bottle piston being slidably retained within said bottle using a loose friction fit;
a pump assembly, said pump assembly comprising:
a housing, a portion of said housing being received in said top opening of said bottle, said housing being releasably secured to said bottle top;
a spool, said spool comprising a chamber being open at a first end of said spool and closed at a second end of said spool, said second end of said spool comprising one or more orifices into said chamber;
a pump piston, said pump piston being slidably disposed upon said spool;
a nozzle head, said nozzle head being connected to said spool with said piston being slidable thereon, said nozzle head comprising one or more chambers being in fluid communication with said spool chamber, said connected nozzle head and spool being slidable with respect to said housing and sealed therebetween; and
a biasing means, said biasing means biasing said nozzle head outward from said housing into a first position;
wherein depressing said outwardly biased nozzle head creates pressure to cause pumping through said one or more orifices of said spool, through said chamber of said spool and said one or more chambers of said nozzle head, and out of said nozzle head; and
wherein said nozzle head no longer being depressed permits said biasing of said nozzle head outward from said housing to seal said spool orifices and thereafter create vacuum pressure to cause said bottle piston to slide within said bottle and prevent air from entering therein.

2. The dispensing device according to claim 1, wherein depressing said outwardly biased nozzle head causes said spool to move relative to said pump piston to expose said one or more orifices of said spool.

3. The dispensing device according to claim 2, wherein depressing said outwardly biased nozzle head causes said connected nozzle head and spool to thereafter reach a second position, said connected nozzle head and spool engaging said piston pump upon reaching said second position.

4. The dispensing device according to claim 3, wherein said nozzle head being depressed to create pressure to cause pumping is by engagement of said connected nozzle head and spool driving said pump piston to cause a volume decrease in said bottle, said volume decrease creating said pressure.

5. The dispensing device according to claim 4, wherein said nozzle head drives said piston pump until said connected nozzle head and spool reach a third position, a portion of said nozzle head engaging said housing upon reaching said third position.

6. The dispensing device according to claim 5, wherein said nozzle head no longer being depressed permits said biasing of said connected nozzle head and spool relative to said pump piston into a fourth position, said spool being sealed upon reaching said fourth position by said spool orifices being covered by said pump piston; and wherein said spool engages said pump piston upon reaching said fourth position.

7. The dispensing device according to claim 7, wherein said biasing of said connected nozzle head and spool drives said piston pump until reaching said first position; and wherein said driving of said piston pump creates said vacuum pressure, said vacuum pressure overcoming said loose friction fit and thereby causing sliding movement of said bottle piston.

8. The dispensing device according to claim 7 further comprising a cylindrical protrusion extending from said housing, and a corresponding recess in said bottle piston; and wherein when said pumping causes said bottle piston to approach said housing, said cylindrical protrusion being received in said bottle piston orifice permits pumping of small amounts of a substance remaining therein.

9. The dispensing device according to claim 8, wherein said one or more chambers of said nozzle head begin at an inlet opening and terminate in a delivery opening; and wherein said inlet opening of said one or more chambers of said nozzle head is in fluid communication with said open first end of said spool chamber.

10. The dispensing device according to claim 9, wherein said bottle piston is slidable retained within said bottle by a bottle plug.

11. The dispensing device according to claim 10, wherein said housing being releasably secured to said bottle top is by threadably connecting said housing to said bottle top.

12. The dispensing device according to claim 11, wherein said pump accommodates flow of said substance wherein said substance has a viscosity in the range of approximately 1,500 cps to 40,000 cps.

13. The dispensing device according to claim 12, wherein said substance comprises a cosmetic substance from the group consisting of: a liquid and a cream.

14. A combination double-piston double-action pump and variable volume cosmetic bottle being usable as a dispensing device, said combination pump and bottle comprising:
a bottle assembly, said bottle having a selectively varying volume being defined by at least one wall, a top, and a slidable bottom, said bottle top being open and said slidable bottom being sealed with respect to said at least one wall;
a pump assembly, said pump assembly comprising: a spool, one or more walls forming a reservoir, and a reservoir piston; said spool and said reservoir piston being connected and having at least a portion therein being slidably disposed within said reservoir to selectively vary a volume of said reservoir; said spool being biased away from a second position to be in a first position, said spool and said reservoir piston being selectively interconnected; at least a portion of said bottle assembly being releasably received within said pump assembly, and with a portion of said pump reservoir being thereby inserted into said bottle through said bottle top;
wherein when a force is applied to said spool and said spool is moved at least a portion of the way from said first position toward said second position, one or more openings in said spool are exposed beyond said reservoir piston and into said pump reservoir; and continued movement of said spool into said second position causes said spool to drive said reservoir piston into said reservoir to cause a decrease in said reservoir volume and cause pumping action; and
wherein when said force is removed from said spool, said biasing moves said spool at least a portion of the way back toward said first position to block said one or more opening in said spool with said reservoir piston, and continued biasing of said spool into said first position causes said spool to drive said reservoir piston and cause an increase in said reservoir volume to thereby create vacuum pressure, said vacuum pressure causing said slidable bottom in said bottle to move a portion of the way toward said bottle top to provide a decrease in said selectively varying volume of said bottle to correspond to said reservoir volume increase.

15. The combination pump and bottle according to claim 14, wherein said spool further comprises a nozzle head, said nozzle head comprising one or more conduits that interconnect with a conduit in said spool; and wherein said volume decrease in said reservoir forces a substance within said reservoir to flow through said conduits and out from said nozzle head.

16. The combination pump and bottle according to claim 15, wherein said nozzle head diverts said flow of said substance at an angle to said spool conduit.

17. The combination pump and bottle according to claim 16, wherein said nozzle head provides a surface for a user to apply pressure to oppose said biasing; and wherein said biasing is by a helical spring.

18. The combination pump and bottle according to claim 17, wherein said slidable bottom of said bottle is retained within said bottle by a bottle plug.

19. The combination pump and bottle according to claim 18, wherein said bottle top comprises external threading and said pump assembly comprises internal threading; and wherein said portion of said bottle assembly being releasably received within said pump assembly is by threadably engaging said bottle top into said pump assembly.

20. The combination pump and bottle according to claim 19, wherein said substance is a cosmetic substance from the group consisting of: a liquid and a cream.
